(19) United States
(12) Patent Application Publication
(10) Pub. No.: US 2008/0101303 A1
(43) Pub. Date: May 1, 2008

(54) HIGH SPEED SHARED CONTROL CHANNEL (HS-SCCH) COMMUNICATION APPARATUS AND METHOD IN WIDEBAND CODE DIVISION MULTIPLE ACCESS (WCDMA) COMMUNICATION SYSTEM

(75) Inventor: Noh-Sun KIM, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/925,572

(22) Filed: Oct. 26, 2007

(30) Foreign Application Priority Data
Oct. 27, 2006 (KR) 2006-0105311

(51) Int. Cl. H04B 7/216

(52) U.S. Cl. 370/335

(57) ABSTRACT

High Speed Shared Control CHannel (HS-SCCH) communicating apparatus and method in Wideband Code Division Multiple Access (WCDMA) wireless communication system are provided. A receiver of a mobile communication terminal in the WCDMA communication system, which includes a speed estimator for determining a transmission interval of a Channel Quality Indicator (CQI) by measuring a channel change speed of a downlink from the signal fed from the communication module, shortening the CQI transmission interval when channel conditions changes quickly, and lengthening the CQI transmission interval when the channel conditions change slowly; and a decoder for interpreting the signal and providing the signal to an upper layer.

### PRIORITY

This application claims priority under 35 U.S.C. §119 to an application filed in the Korean Intellectual Property Office on October 27, 2006 and assigned Serial No. 2006-105311, the contents of which are incorporated herein by reference.

### BACKGROUND OF THE INVENTION

1. Field of the Invention

The present invention relates generally to High Speed Shared Control CHannel (HS-SCCH) communication apparatus and method in Wideband Code Division Multiple Access (WCDMA) wireless communication system, and in particular, to an apparatus and method for transmitting control information in a high-speed uplink dedicated control channel.

2. Description of the Related Art

Mobile communication systems are advancing toward high-speed and high-quality wireless data packet communication systems to provide data service and multimedia service, beyond the voice centered service delivery. High Speed Downlink Packet Access (HSDPA) and 1× Evolution in Data and Voice (EV-DV) have been developed based on the 3^{rd} Generation Partnership Project (3 GPP) and 3 GPP2 standards to address the high-speeds of over 2 Mbps and high-quality wireless data packet delivery services.

Typically, it is the radio channel conditions that interrupt the high-speed and high-quality data services. The radio communication channel is subject to the frequency condition changes because of white noise, signal power variation from fading, shadowing, Doppler effect according to terminal movement and frequency speed change, and interference by other users or multipath signals. To provide the high speed wireless data packet service, another advance technique beyond the general techniques of the exiting 2^{nd} Generation (2G) or 3^{rd} Generation (3G) mobile communication system is required to enhance the adaptability to the channel changes. The high speed control scheme adopted by the existing system can enhance the adaptability to channel changes, whereas the 3 GPP and 3 GPP2 working on the high-speed data packet transfer system standardization are discussing the usage of Adaptive Modulation and Coding (AMC) scheme and Hybrid Automatic Repeat reQuest (HARQ) scheme.

The AMC scheme alters the modulation scheme and the coding rate of a channel coder according to the changes of the downlink channel conditions. In general, a terminal measures the Signal to Noise Ratio (SNR) of the downlink and transmits the information to the Base Station (BS) through the uplink. The BS predicts the downlink channel conditions based on the received information and designates the suitable modulation scheme and the suitable coding rate of the channel coder based on the prediction.

The HARQ scheme requests packet retransmission(s) to correct errors in the packets when the initially received data packets are corrupted. The HARQ scheme is classified into a Chase Combining (CC) scheme, Full Incremental Redundancy (FIR) scheme, and Partial Incremental Redundancy (PIR) scheme. The CC scheme retransmits the same packet as the initial transmitted packet. The FIR scheme retransmits a packet consisting of redundancy bits generated at a channel coder, rather than the same packet. The PIR scheme retransmits a packet consisting of a set of information bits and new redundancy bits.

The AMC scheme and the HARQ scheme are independent techniques to raise the adaptability to the link changes. When the two schemes are combined, the system performance can be ever more greatly improved. When the modulation scheme and the coding rate of the channel coder suitable for the channel conditions are determined according to the AMC scheme, the corresponding data packet is transmitted. When the receiver fails to decode the received data packet, the receiver requests the retransmission. Accordingly, the BS accepts the retransmission request of the receiver and then retransmits a data packet in accordance with a prescribed HARQ scheme.

To support the above schemes, it is necessary to exchange control signals between a user terminal and the BS. Particularly, in the HSDPA communication system, a control channel used to deliver the control signals includes High Speed Shared Control CHannel (HS-SCCH) and High Speed Dedicated Physical Control CHannel (HS-DPCCH). The HS-SCCH delivers control signals relating to the High Speed Physical Downlink Shared CHannel (HS-PDSCH), and the HS-DPCCH delivers control information in the uplink.

FIG. 1 illustrates structures of HS-SCCH and HS-PDSCH adopted in the HSDPA communication system.

The HS-SCCH 110 of FIG. 1 is transmitted on 2 slots ahead of the HS-PDSCH 120. The HS-SCCH 110 delivers control information required for the decoding of the HS-PDSCH 120. Table 1 shows the types of the control information to support the decoding of the HS-PDSCH 120.

TABLE 1

| 1^{st} part | 2^{nd} part |
|---|---|
| channelized code set information | transport block (TB) size information |
| (7 bits) | (6 bits) |
| modulation scheme information | HARQ process ID (3 bits) |
| (1 bit) | |
| | redundancy and constellation version |
| | information (3 bits) |
| | new data indicator (1 bit) |
| | user ID (16 bits) |

The HS-SCCH 110 includes three slots. The first slot carries the channelized code set information and the modulation scheme information, and the two subsequent slots carry the TB size information, the HARQ process ID, the redundancy and constellation version information, the new data indicator, and the user ID. As such, the HS-SCCH 110 is divided to two parts in order to rapidly acquire the most fundamental information (the channelized code set information and the modulation scheme information) to decode the HS-PDSCH 120.

The following is a description of the control information sent over the HS-SCCH.

As for the Channelized Code Set (CCS) information, the HSDPA communication system uses 15 Orthogonal Variable Spreading Factor (OVSF) codes with a maximum Spreading Factor (SF) of 16. The CCS information indicates the number of channelized codes used to transmit the HS-PDSCH. The CCS information consists of 7 bits a shown in Table 1. The terminal acquires the number and the type of the channelized codes required for the dispreading.

FIG. 2 illustrates OVSF code tree of the HSDPA communication system.

Each channelized code (OVSF code) of FIG. 2 can be represented as C(i,j) according to its position in the code tree. The variable i of C(i,j) indicates the SF and the variable j indicates the order from the left in the code tree. For example, C(16,0) indicates the SF 16 and the OVSF code at the first position from the left. FIG. 2 shows the case where 10 OVSF codes from the 7^{th} position to the 16^{th} position based on the SF 16, that is, from C(16,6) to C(16,15) are allocated for the HS-PDSCH. A plurality of available OFSM codes can be multiplexed to a plurality of terminals. The number of the codes allocated to the terminals and the position of the codes in the code tree are determined by the BS and transmitted to the terminals using the CCS information of the HS-SCCH.

As for the modulation scheme information, the AMC scheme adaptively alters the coding rate of the channel coder and the modulation scheme of the modulator according to the channel conditions. When using two modulation schemes of Quadrature Phase Shift Keying (QPSK) and 16-ary Quadrature Amplitude Modulation (16 QAM), the BS needs to transmit information indicating to the terminal the modulation scheme and the coding rate of current packet at every packet transfer. Since the coding rate can be acquired from the information of the TB set, the HS-PDSCH channelized code set, and the modulation scheme, the BS only includes the information relating to the modulation scheme in the modulation scheme information.

The TB size information relates to the size of the TB transmitted from the logical channel to the physical channel.

As for the HARQ process ID (HAP), the HARQ scheme newly adopts two schemes as follows to increase the transmission efficiency of Automation Retransmission Request (ARQ). The first scheme performs the retransmission request and response between the terminal and the BS. In the second scheme, the receiver temporarily stores data containing errors and combines the stored data with the retransmitted data. The typical Stop and Wait (SAW) ARQ scheme transmits the next packet only when an ACKnowledgement (ACK) of the previous packet is received. When transmitting the next packet after receiving the ACK of the previous packet, there may be a need to wait for the ACK even if the packet to transmit is ready for transmission. To address this problem, the suggested n-channel SAW ARQ can raise the channel efficiency by successively transmitting a plurality of packets while the ACK of the previous packet is not received. Specifically, n-ary time division logical channels are set between the terminal and the BS. The BS uses a specific time or channel number for HARQ processing information to indicate which time division channel carries the corresponding packet. Using the HARQ process ID, the terminal indicates which channel of the originally-ordered logical channels delivers the packet received at a certain time.

The redundancy and constellation version information differs according to 16 QAM and QPSK and includes parameter s, parameter r, and parameter b as shown in Table 2. Table 2 lists the Redundancy Version (RV) coding for 16 QAM. The parameter s and the parameter r are used for the rate matching. The parameter b is information relating to the constellation rearrangement as shown in Table 4. The transmitter transmits signals using one of four constellations of Table 4.

TABLE 2

| Xrv | | | |
|---|---|---|---|
| (value) | s | r | b |
| 0 | 1 | 0 | 0 |
| 1 | 0 | 0 | 0 |
| 2 | 1 | 1 | 1 |
| 3 | 0 | 1 | 1 |
| 4 | 1 | 0 | 1 |
| 5 | 1 | 0 | 2 |
| 6 | 1 | 0 | 3 |
| 7 | 1 | 1 | 0 |

Table 2 shows RV coding values with respect to 16 QAM.

TABLE 3

| Xrv | | |
|---|---|---|
| (value) | s | r |
| 0 | 1 | 0 |
| 1 | 0 | 0 |
| 2 | 1 | 1 |
| 3 | 0 | 1 |
| 4 | 1 | 2 |
| 5 | 0 | 2 |
| 6 | 1 | 3 |
| 7 | 0 | 3 |

Table 3 shows RV coding values with respect to QPSK.

TABLE 4

| b | Output bit Sequence | Operation |
|---|---|---|
| 0 | s1, s2, s3, s4 | None |
| 1 | s3, s4, s1, s2 | Swapping MSBs with LSBs |
| 2 | S_1, s_2, - atop {s-3}, - | Inversion of the logical values of |
| | atop {s_4} | LSBs |
| 3 | S_3, s_4, - atop {s_1}, - | 1 & 2 |
| | atop {s_2} | |

Table 4 shows the information as to the constellation rearrangement with respect to the parameter b and indicates four constellation types, of which one is used.

The New data Indicator (NI) indicates whether the packet is initially transmitted or retransmitted. 1 bit is allocated to the NI. The user ID (UE ID) is a unique ID assigned to each user. For every time slot, the terminal checks whether HS-SCCH and HS-PDSCH are allocated to itself using the UE ID.

The control information transmitted over the HS-SCCH is determined by the ACK/NonACKnowledgement (NACK) and the Channel Quality Indicator (CQI) fed back from the receiver. When ACK is fed back from the receiver and a new packet is transmitted, the NI is set to new data (NEW). The modulation scheme and the channelized code set (CCS) are determined using the CQI fed back from the receiver.

FIG. 3 illustrates a general HS-DPCCH structure.

HS-DPCCH of FIG. 3, which is the uplink channel from the terminal to the BS, includes three slots. The three slots are divided to two parts. The first part includes 2560 chips and carries 10-bit ACK/NACK information. The second part includes 5120 chips and carries 20-bit CQI. As discussed earlier, the CQI is the information to indicate to the BS of the terminal channel information and is transmitted from the terminal to the BS.

The terminal feeds the measured CQI back to the BS over 2 slots. The feedback CQI is used to determine the modulation scheme and the channelized code set. If the CQI is sent to the BS over 2 slots at a Transmission Time Interval (TTI) of 2 msec, it is suitable to transmit the CQI at every TTI in order to efficiently transfer information under the rapid change of the channel conditions or under the rapid channel condition change due to the rapid movement of the terminal.

However, where there are only small or slow changes in the channel conditions or if the channel condition changes slowly because of the slow movement of the terminal, the transmission of the CQI at every TTI causes unnecessary overhead and unnecessary power consumption of the MS.

### SUMMARY OF THE INVENTION

An aspect of the present invention is to substantially solve at least the above problems and/or disadvantages and to provide at least the advantages below. Accordingly, an aspect of the present invention is to provide a HS-SCCH communication apparatus and method in Wideband Code Division Multiple Access (WCDMA) communication system.

Another aspect of the present invention is to provide an apparatus and method for lowering overhead caused when unnecessary information bits are transmitted and decreasing terminal power consumption by estimating channel conditions, extending a transmission interval of channel indicator when channel changes are slow, and in WCDMA communication system.

A further aspect of the present invention is to provide an apparatus and method for maximizing system capacity by estimating channel conditions, shortening a transmission interval of a channel indicator with respect to rapid channel condition changes, and accurately informing the BS of the terminal channel condition so as to determine a modulation scheme and a coding rate.

The above aspects are achieved by providing a receiver of a mobile communication terminal in WCDMA communication system, which includes a speed estimator for determining a transmission interval of a Channel Quality Indicator (CQI) by measuring a channel change speed of a downlink channel, shortening the CQI transmission interval when channel conditions change quickly, and lengthening the CQI transmission interval when the channel conditions change slowly; and a decoder for interpreting the signal and providing the interpretation result to an upper layer.

According to one aspect of the present invention, a transmitter of a mobile communication terminal of WCDMA communication system, includes a CQI generator for outputting CQI measured at intervals according to a CQI repetition factor, the intervals determined by measuring a channel quality of a downlink, shortening a CQI transmission interval when channel conditions change quickly, and lengthening the CQI transmission interval when the channel conditions change slowly; and a communication module for processing and transmitting the CQI.

According to another aspect of the present invention, a system using CQI in WCDMA communication system includes a mobile communication terminal for transmitting a CQI by measuring a channel change speed of a downlink, shortening a CQI transmission interval when channel conditions change quickly, and lengthening the CQI transmission interval when the channel conditions change slowly, outputting the CQI, and a Base Station (BS) for receiving the CQI from the mobile communication terminal and determining a modulation scheme and a channelized code set to be used by the mobile communication terminal.

According to a further aspect of the present invention, a receiving method of a mobile communication terminal in WCDMA communication system includes determining a transmission interval of a CQI by measuring a channel change speed of a downlink channel, shortening the CQI transmission interval when channel conditions changes quickly, and lengthening the CQI transmission interval when the channel conditions change slowly; and interpreting the processed signal and providing the signal to an upper layer.

According still another aspect of the present invention, a transmitting method of a mobile communication terminal of WCDMA communication system includes outputting CQI measured at intervals according to a CQI repetition factor, the intervals determined by measuring a channel quality of a downlink, shortening a CQI transmission interval when channel conditions change quickly, and lengthening the CQI transmission interval when the channel conditions change slowly; and transmitting the CQI.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates structures of the HS-SCCH and the HS-PDSCH used in a general HSDPA communication system;

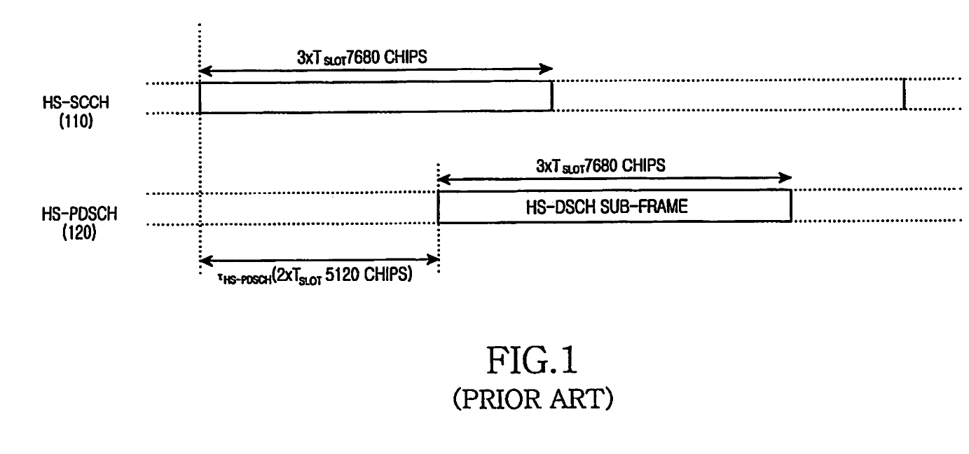

FIG. 2 illustrates OVSF code tree of the general HSDPA communication system;

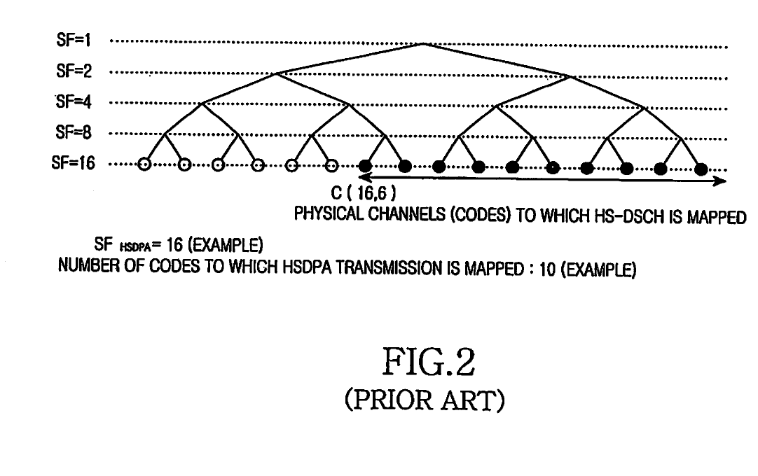

FIG. 3 illustrates a general HS-DPCCH structure;

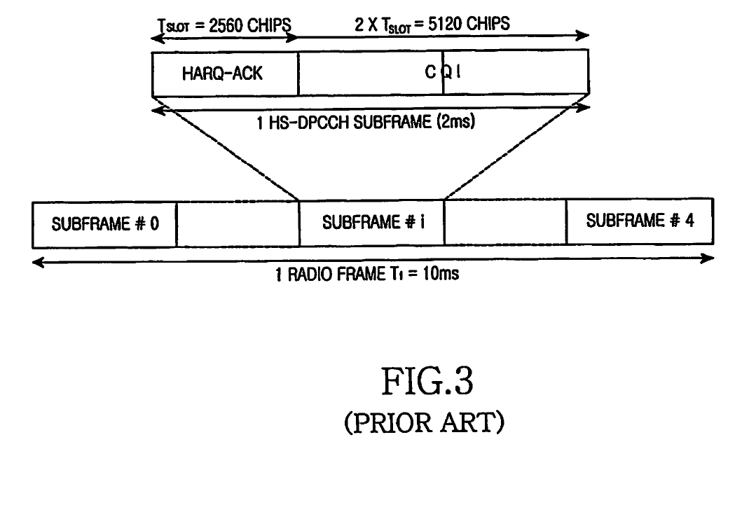

FIG. 4 illustrates a detailed structure of an Infinite Impulse Response (IIR) filter according to the present invention;

FIG. 5 illustrates a structure of a terminal receiver in a High Speed Downlink Packet Access (HSDPA) communication system according to the present invention;

FIG. 6 illustrates a structure of a terminal transmitter in the HSDPA communication system according to the present invention;

FIG. 7 illustrates a structure of Base Station (BS) receiver in the HSDPA communication system according to the present invention;

FIG. 8 is a flowchart of operations of a speed estimator of the terminal in the HSDPA communication system according to the present invention; and

FIG. 9 is a flowchart of transmission operation of the terminal based on Channel Quality Indicator (CQI) repetition factor in the HSDPA communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a High Speed Shared Control CHannel (HS-SCCH) communicating apparatus and method in a Wideband Code Division Multiple Access (WCDMA) communication system. While High Speed Downlink Packet Access (HSDPA) is used by way of example, the present invention is applicable to any other apparatus and method for transmitting Channel Quality Indicator (CQI).

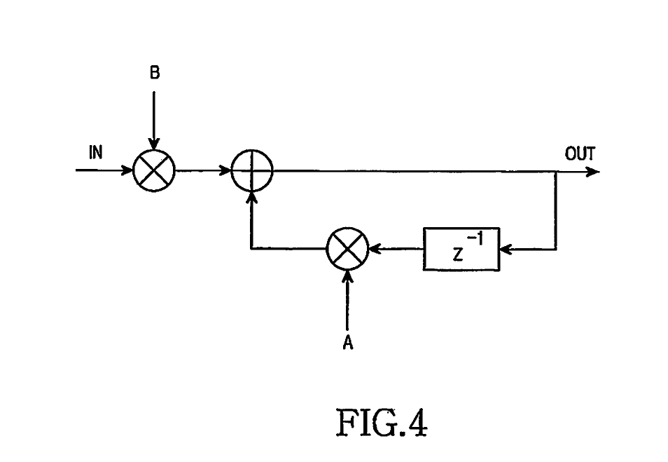

The channel estimation scheme of the present invention employs a primary Infinite Impulse Response (IIR) filter as shown in FIG. 4, and its input and output relational expression is represented by Equation (1).

y(n)=b×x(n)+a·y(n−1) (1)

In Equation (1), y(n) denotes a current output signal, x(n) denotes a current input signal, and y(n−1) denotes a previous output signal. As can be seen from Equation (1), the output signal y(n) is the sum of the input signal x(n) and a once-delayed output signal y(n−1) multiplied by respective constants a and b the a is a constant which controls a ratio of influence of the current input signal, and the b a constant which controls a ratio of influence of the previous output signal.

The frequency characteristic of the primary IIR filter is expressed by Equation (2).

$$H ( {e}^{j ω} ) = \frac{b}{1 - a \cdot {e}^{- j ω}} \qquad ( 2 )$$

When the frequency is zero, a direct current (DC) gain of the primary IIR filter has a value of ω=0 and thus expressed as in Equation (3).

$$\vert H ( 1 ) \vert = \frac{\vert b \vert}{\vert 1 - a \vert} \qquad ( 3 )$$

Hence, when a condition of |b|=|1−a| is satisfied, the DC gain is normalized to ‘1’.

The channel estimator output is expressed as in Equation (4). The auto-correlation function using the channel estimator output can be acquired based on Equation (5).

$$\begin{matrix}\tilde{c} ( n ) = {A}_{p} c ( n ) + {N}_{1} ( n ) & ( 4 ) \\ {R}_{\overline{c}} ( l ) = {\sum }_{n = 1}^{{M}_{pilot}} \vert \overline{c} ( n ) \vert \cdot \vert \overline{c} ( n + l ) \vert & ( 5 )\end{matrix}$$

In Equation (4), c̅(n) denotes predictive channel response, A_{P} denotes the magnitude of pilot channel, c(n) denotes paging channel response, N₁(n) denotes white noise.

In Equation (5), R_{\tilde{c}} (l) denotes auto-correlation function of the predictive channel response, \tilde{c}(n) and \tilde{c}(n+l) denotes predictive channel response, Mₚᵢₗₒₜ denotes the number of pilots.

The minimum value or the mean value of the auto-correlation function reflects the channel variation speed. Hence, the speed prediction parameter β is defined as Equation (6).

β=min{R _{c̅}(l)/max(R _{c̅})} or

β=mean{R _{c̅}(1) max(R _{c̅})} (6)

In Equation (6), R _{c̅}(l) denotes auto-correlation function of the predictive channel response, β denotes speed prediction parameter.

The speed prediction parameter β satisfies 0<=β<=1 and is the normalization of the auto-correlation function, to thus fully represent the channel changes. In the case of the slowly fading channel condition with little channel change, the speed prediction parameter is close to ‘1’. In case of the fast or quickly fading with the rapid channel change, the speed prediction parameter is close to ‘0’.

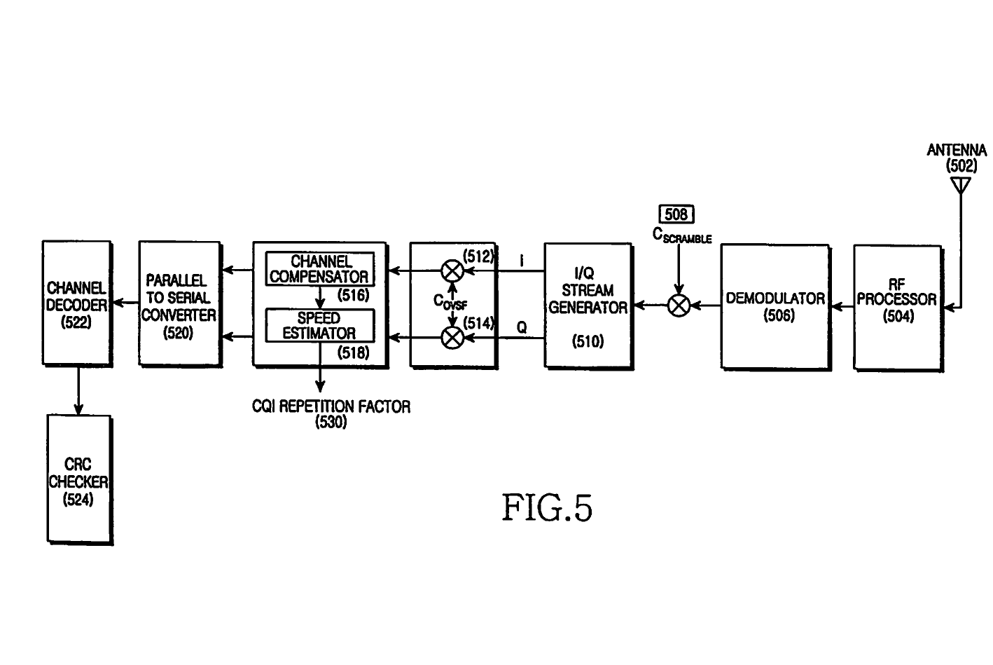

FIG. 5 illustrates a structure of a terminal receiver in HSDPA communication system according to the present invention.

The receiver of FIG. 5 includes an antenna 502, a Radio Frequency (RF) processor 504, a demodulator 506, a descrambler 508, an I/Q stream generator 510, multipliers 512 and 514, a channel compensator 516, a speed estimator 518, a parallel to serial converter 520, a channel decoder 522, and a Cyclic Redundancy Check (CRC) checker 524.

The RF processor 504 converts an RF band signal received on the antenna 502 to a baseband signal and outputs the baseband signal. The demodulator 506 demodulates and outputs the signal fed from the RF processor 504 using a scheme corresponding to the modulation scheme used at the transmitter (i.e. the BS). The descrambler 508 descrambles and outputs the signal fed from the demodulator 506 to a preset scrambling code C_{scramble}. The I/Q stream generator 510 splits and outputs the complex signal fed from the descrambler 508 into an I bit stream and a Q bit stream. The multiplier 512 despreads the I bit stream from the I/Q stream generator 510 to a preset spreading code C_{ovsf} and outputs the spreading code C_{ovsf}. The multiplier 514 despreads and outputs the Q bit stream from the I/Q stream generator 510 to a preset spreading code C_{ovsf}. The channel compensator 516 compensates for distortion generated from the radio channels with respect to the signals fed from the multipliers 512 and 514. The parallel to serial converter 520 converts the parallel signal from the channel compensator 512 to a serial signal and outputs the serial signal to the channel decoder 522.

The signal input to the speed estimator 518 is expressed as Equation (4), wherein the auto-correlation function is expressed as Equation (5). The minimum value or the mean value of the auto-correlation function reflects the channel change speed. Accordingly, the speed prediction parameter β is defined as Equation (6). The speed prediction parameter β satisfies 0<=β<=1 and is the normalization of the auto-correlation function, to thus sufficiently represent the channel change status.

In the case of the slow fading with little channel change, the speed prediction parameter is close to ‘1’. In case of the fast fading with the fast channel change, the speed prediction parameter is close to ‘0’.

When the speed prediction parameter β is provided, the channel speed is determined. The determined channel speed is compared with a channel speed corresponding to a reference value Tβ. The reference value Tβ is a turning point to change a mapping rule of the CQI transmission interval and may vary according to the structure and the performance of the receiver. Since the structure and the performance of the receiver are set by the designer or the system standard, the channel speed value corresponding to Tβ is obtained from the performance experiment of the receiver. That is, the channel speed corresponding to Tβ is measured through constant experiments. Tβ is a threshold, and the Channel Quality Indicator (CQI) transmission interval is determined based on the magnitude relation between Tβ and the speed prediction parameter β. CQI transmission interval of the existing standard (i.e. the 3 GPP standard) is a maximum of 160 msec (0, 2, 4, 8, 10, 20, 40, 80, 160 msec). The CQI transmission interval is determined in the range of 0˜160 msec depending on the magnitude difference between the speed prediction parameter β and Tβ.

Accordingly, the Tβ turning point needs to be properly set because the structure and the performance of the receiver differ according to the designer or the system standard.

The CRC checker 524 checks for errors using the CRC in relation with the signal fed from the parallel to serial converter 520.

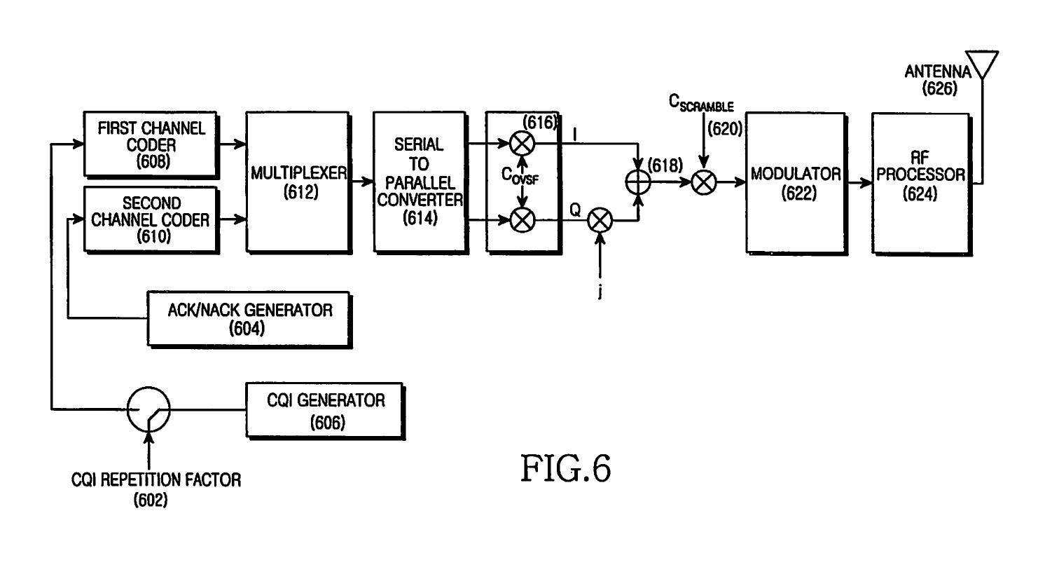

FIG. 6 illustrates a structure of a terminal transmitter in the HSDPA communication system according to the present invention.

The transmitter of FIG. 6 includes an ACK/NACK generator 604, a CQI generator 606, a CQI repetition factor 602, a first channel coder 608, a second channel coder 610, a multiplexer 612, a serial to parallel converter 614, a spreader 616, an adder 618, a scrambler 620, a modulator 622, an RF processor 624, and an antenna 626.

The ACK/NACK generator 604 generates and provides a result value of 1 or 0 according to whether an ACK/NACK is received for the transmitted packet.

The CQI generator 606 generates the CQI by measuring the channel quality of the terminal. Whether to send the generated bit stream (i.e. the CQI) is determined by the CQI repetition factor generated at the speed estimator 518 of FIG. 5. The CQI repetition factor indicates the CQI transmission interval. That is, the CQI transmission interval is determined through the process of FIG. 5 and the CQI is determined according to the determined interval.

The generated CQI is encoded at the first channel coder 608. The encoded CQI and the ACK/NACK information encoded at the second channel coder 610 pass through the multiplexer 612 and constitute one HS-DPCCH frame by occupying two slots and one slot of the HS-DPCCH, respectively.

The serial to parallel converter 614 divides the generated bit stream (i.e. the HS-DPCCH frame) into a real part and an imaginary part and outputs them in parallel. The spreader 616 spreads the signals fed from the serial to parallel converter 614 to preset spreading codes C_{ovsf}, generates and outputs an in-phase (I) signal and a quadrature (Q) signal.

The adder 618 adds and outputs the I signal and the Q signal fed from the spreader 616. The scrambler 620 scrambles and outputs the output signal from the adder 618 according to a preset scrambling code C_{scramble}.

The modulator 622 modulates and outputs the signal from the scrambler 620 using a preset modulation scheme. The RF processor 624 converts the baseband signal from the modulator 622 to an RF band signal and transmits the RF signal on the antenna 626.

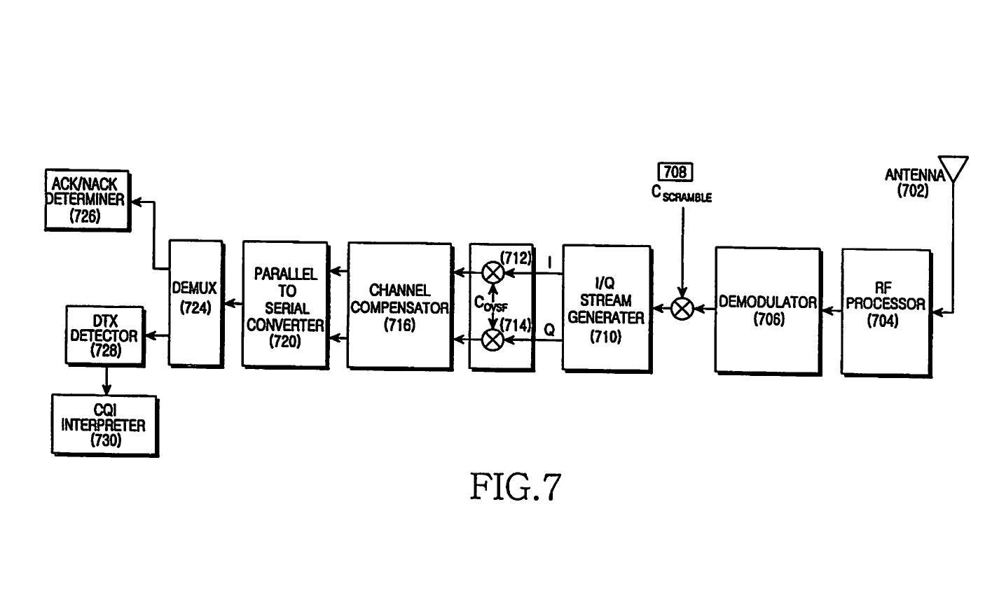

FIG. 7 illustrates a structure of Base Station (BS) receiver in the HSDPA communication system according to the present invention.

The receiver of FIG. 7 includes an antenna 702, an RF processor 704, a demodulator 706, a descrambler 708, an I/Q stream generator 710, multipliers 712 and 714, a channel compensator 716, a parallel to serial converter 720, a demultiplexer (DEMUX) 724, an ACK/NACK determiner 726, a Discontinuous Transmission (DTX) detector 728, and a CQI interpreter 730.

The RF processor 704 converts an RF band signal received on the antenna 702 to a baseband signal and outputs the baseband signal. The demodulator 706 demodulates and outputs the signal fed from the RF processor 704 using a scheme corresponding to the modulation scheme used at the transmitter (i.e. the terminal). The descrambler 708 descrambles and outputs the signal fed from the demodulator 706 according to a preset scrambling code C_{scramble}. The I/Q stream generator 710 splits and outputs the complex signal from the descrambler 708 into an I bit stream and a Q bit stream. The multiplier 712 despreads and outputs the I bit stream from the I/Q stream generator 710 according to a preset spreading code C_{ovsf}. The multiplier 714 despreads and outputs the Q bit stream from the I/Q stream generator 710 according to a preset spreading code C_{ovsf}. The channel compensator 716 compensates for distortion generated when passing through the radio channels with respect to the signals from the multipliers 712 and 714 and outputs the compensated signal. The parallel to serial converter 720 converts the parallel signal from the channel compensator 712 to a serial signal and provides the serial signal to the DEMUX 724. The DEMUX 724 outputs the fed bit stream to the ACM/NACK determiner 726 and the DTX detector 728 respectively.

The DTX detector 728 detects whether the CQI is transmitted and then outputs the CQI to the CQI interpreter 730 when the CQI is detected. The CQI interpreter 730 receives the CQI from the DTX detector 728 and determines the modulation scheme and the channelized code set (CCS).

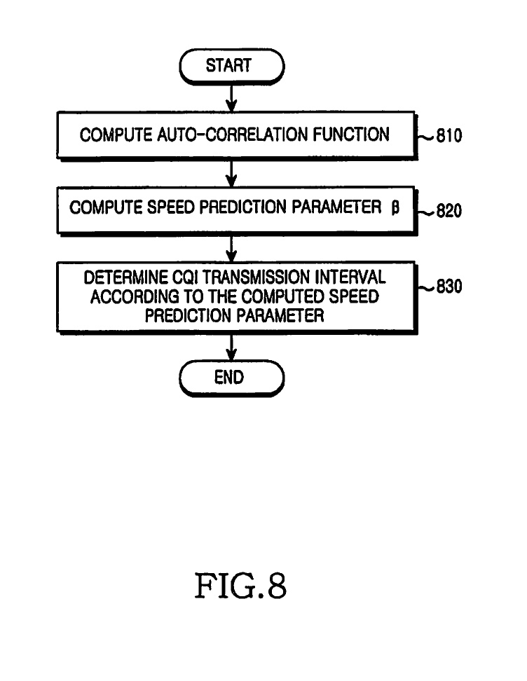

FIG. 8 is a flowchart of operations of the speed estimator of the terminal in the HSDPA communication system according to the present invention.

The speed estimator of FIG. 8 computes the auto-correlation function using the input signal of Equation (4) and the expression of Equation (5) in step 810. The minimum value or the mean value of the auto-correlation function reflects the channel change speed.

The speed estimator computes the speed prediction parameter β using the auto-correlation function in step 820. The speed prediction parameter β is defined by Equation (6). Since the speed prediction parameter β satisfies 0<=β<=1 and is the normalization of the auto-correlation function, it can sufficiently represent the channel changes. In more detail, in the slow fading with little channel change, the speed prediction parameter is close to ‘1’. In the fast fading with the fast channel change, the speed prediction parameter is close to ‘0’.

The speed estimator determines the CQI transmission interval using the speed prediction parameter β in step 830. The reference value Tβ is a turning point to change the mapping rule of the CQI transmission interval and may vary according to the structure and the performance of the receiver. Since the structure and the performance of the receiver are set by the designer or the system standard, the channel speed value corresponding to Tβ is obtained through the performance of experiments of the receiver. That is, the channel speed corresponding to Tβ is measured through constant experiments. Tβ is a threshold, and the CQI transmission interval is determined based on the magnitude relation between Tβ and the speed prediction parameter β. The CQI transmission interval of the existing standard (i.e. the 3 GPP standard) is a maximum of 160 msec (0, 2, 4, 8, 10, 20, 40, 80, 160 msec). Namely, the CQI transmission interval is determined in the range of 0˜160 msec depending on the speed prediction parameter β and Tβ. Accordingly, those values can be properly selected based on the Tβ. The Tβ turning point needs to be properly set because the structure and the performance of the receiver differ according to the designer or the system standard.

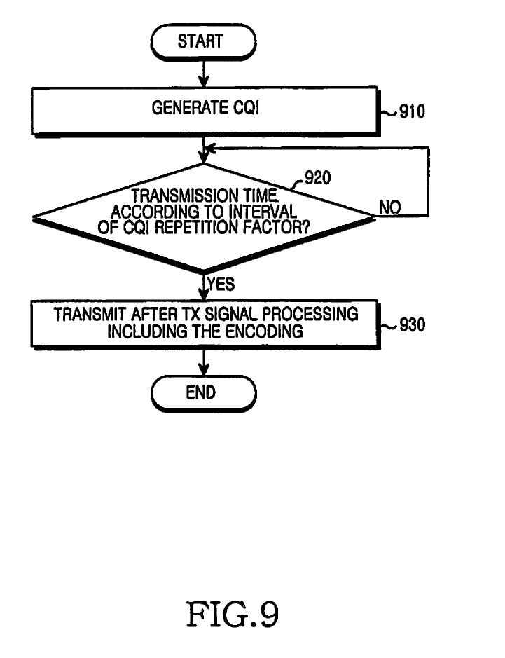

FIG. 9 is a flowchart of transmission operation of the terminal based on CQI repetition factor in the HSDPA communication system according to the present invention.

The terminal of FIG. 9 generates CQI from the signal received from the BS in step 910.

When the transmission time occurs, according to the interval of the CQI repetition factor generated in the process of FIG. 8, in step 920, the terminal transmits the CQI after performing the transmit signal processes (e.g. coding, multiplexing, serial to parallel conversion, multiplying, scrambling, modulating, and baseband processing) in step 930.

As set forth above, the channel conditions of the terminal are transmitted to the network in real time by shortening the CQI transmission interval in the severe channel change or by lengthening the CQI transmission interval in the moderate channel change. Therefore, it is possible to reduce the transmissions of unnecessary uplink control information.

Consequently, the terminal power consumption can be reduced and the uplink interference can be efficiently rejected, to increase the system capacity. Furthermore, since the terminal adjusts and transmits the CQI repetition factor in accordance with the channel conditions, the intended information can be acquired at the desired time by adopting to the channel conditions in real time.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A receiver of a mobile communication terminal in a Wideband Code Division Multiple Access (WCDMA) communication system, comprising:
a speed estimator for determining a transmission interval of a Channel Quality Indicator (CQI) by measuring a channel change speed of a downlink channel, shortening the CQI transmission interval when channel conditions changes quickly, and lengthening the CQI transmission interval when the channel conditions change slowly; and
a decoder for interpreting, providing the interpretation result to an upper layer.

2. The receiver of claim 1, wherein the speed estimator determines the transmission interval of the CQI by computing a speed prediction parameter β and comparing the speed prediction parameter β with a threshold Tβ which changes a mapping rule of the CQI transmission interval.

3. The receiver of claim 2, wherein the speed prediction parameter β is determined based on
β=min{R _{c̅}(l)/max(R _{c̅})} or β=mean{R _{c̅}(l)/max(R _{c̅})}
where R _{c̅}(l) denotes auto-correlation function of the predictive channel response, β denotes speed prediction parameter. The speed prediction parameter β satisfies 0<=β<=1 and is the normalization of the auto-correlation function, to thus sufficiently represent the channel changes, the speed prediction parameter is close to ‘1’ in a slow fading environment with little channel change, and the speed prediction parameter is close to ‘0’ in a fast fading environment with rapid channel changes, and R_{c}(I) denotes auto-correlation function of the predictive channel response.

4. A transmitter of a mobile communication terminal of a Wideband Code Division Multiple Access (WCDMA) communication system, comprising:
a Channel Quality Indicator (CQI) generator for outputting CQI measured at intervals according to a CQI repetition factor, the intervals determined by measuring a channel quality of a downlink, shortening a CQI transmission interval when channel conditions change quickly, and lengthening the CQI transmission interval when the channel conditions change slowly; and
a communication module for processing and transmitting the CQI.

5. The transmitter of claim 4, wherein the CQI repetition factor is the CQI transmission interval determined by computing a speed prediction parameter β and comparing the speed prediction parameter β with a threshold Tβ which changes a mapping rule of the CQI transmission interval.

6. The transmitter of claim 5, wherein the speed prediction parameter β is determined based on
β=min{R _{c̅}(l)/max(R _{c̅})} or β=mean{R _{c̅}(l)/max(R _{c̅})}
where R _{c̅}(l) denotes auto-correlation function of the predictive channel response, β denotes speed prediction parameter. The speed prediction parameter β satisfies 0<=β<=1 and is the normalization of the auto-correlation function, to thus sufficiently represent the channel changes, the speed prediction parameter is close to ‘1’ in a slow fading environment with little channel change, and the speed prediction parameter is close to ‘0’ in a fast fading environment with rapid channel changes and R_{c}(l) denotes auto-correlation function of the predictive channel response.

7. A system using a Channel Quality Indicator (CQI) in a Wideband Code Division Multiple Access (WCDMA) communication system, comprising:
a mobile communication terminal for determining a transmission interval of a Channel Quality Indicator (CQI) by measuring a channel change speed of a downlink channel, shortening the CQI transmission interval when channel conditions changes quickly, and lengthening the CQI transmission interval when the channel conditions change slowly, and outputting the CQI, and
a Base Station (BS) for receiving the CQI from the mobile communication terminal and determining a modulation scheme and a channelized code set for the mobile communication terminal.

8. The system of claim 7, wherein the mobile communication terminal determines the CQI transmission interval by computing a speed prediction parameter β and comparing the speed prediction parameter β with a threshold Tβ which changes a mapping rule of the CQI transmission interval.

9. The system of claim 8, wherein the speed prediction parameter β is determined based on
β=min{R _{c̅}(l)/max(R _{c̅})} or β=mean{R _{c̅}(l)/max(R _{c̅})}
where R _{c̅}(l) denotes auto-correlation function of the predictive channel response, β denotes speed prediction parameter. The speed prediction parameter β satisfies 0<=β<=1 and is the normalization of the auto-correlation function, to thus fairly represent the channel changes, the speed prediction parameter is close to ‘1’ in a slow fading environment with little channel change, and the speed prediction parameter is close to ‘0’ in a fast fading environment with rapid channel changes, and R_{c}(l) denotes auto-correlation function of the predictive channel response.

10. A receiving method of a mobile communication terminal in a Wideband Code Division Multiple Access (WCDMA) communication system, the method comprising:
determining a transmission interval of a Channel Quality Indicator (CQI) by measuring a channel change speed of a downlink from the processed signal, shortening the CQI transmission interval when channel conditions changes quickly, and lengthening the CQI transmission interval when the channel conditions change slowly; and
interpreting the processed signal and providing the signal to an upper layer.

11. The receiving method of claim 10, wherein the CQI transmission interval determining step determines the CQI transmission interval by computing a speed prediction parameter β and comparing the speed prediction parameter β with a threshold Tβ which changes a mapping rule of the CQI transmission interval.

12. The receiving method of claim 11, wherein the speed prediction parameter β is determined based on
β=min{R _{c̅}(l)/max(R _{c̅})} or β=mean{R _{c̅}(l)/max(R _{c̅})}
where R _{c̅}(l) denotes auto-correlation function of the predictive channel response, β denotes speed prediction parameter. The speed prediction parameter β satisfies 0<=β<=1 and is the normalization of the auto-correlation function, to thus fairly represent the channel changes, the speed prediction parameter is close to ‘1’ in a slow fading environment with little channel change, and the speed prediction parameter is close to ‘0’ in a fast fading environment with rapid channel changes, and R_{c}(l) denotes auto-correlation function of the predictive channel response.

13. A transmitting method of a mobile communication terminal of a Wideband Code Division Multiple Access (WCDMA) communication system, the method comprising:
outputting a Channel Quality Indicator (CQI) measured at intervals according to a CQI repetition factor, the intervals determined by measuring a channel quality of a downlink, shortening a CQI transmission interval when channel conditions change quickly, and lengthening the CQI transmission interval when the channel conditions change slowly; and transmitting the CQI.

14. The transmitting method of claim 13, wherein the CQI repetition factor is the CQI transmission interval determined by computing a speed prediction parameter β and comparing the speed prediction parameter β with a threshold Tβ which changes a mapping rule of the CQI transmission interval.

15. The transmitting method of claim 14, wherein the speed prediction parameter β is determined based on
β=min{R _{c̅}(l)/max(R _{c̅})} or β=mean{R _{c̅}(l)/max(R _{c̅})}
where R _{c̅}(l) denotes auto-correlation function of the predictive channel response, β denotes speed prediction parameter. The speed prediction parameter β satisfies 0<=β<=1 and is the normalization of the auto-correlation function, to thus fairly represent the channel changes, the speed prediction parameter is close to ‘1’ in a slow fading environment with little channel change, and the speed prediction parameter is close to ‘0’ in a fast fading environment with rapid channel changes, and R_{c}(l) denotes auto-correlation function of the predictive channel response.
